(19) United States
(12) Patent Application Publication
(10) Pub. No.: US 2016/0234747 A1
(43) Pub. Date: Aug. 11, 2016

(54) MOBILE DEVICE AND METHOD FOR HANDLING NEIGHBOR CELL MEASUREMENT

(71) Applicant: HTC Corporation, Taoyuan City (TW)

(72) Inventors: Chen-Huang Fan, Taoyuan City (TW); Yu-Chuan Lai, Taoyuan City (TW); Chien-Nan Lin, Taoyuan City (TW)

(21) Appl. No.: 14/614,411

(22) Filed: Feb. 5, 2015

(51) Int. Cl. H04W 36/30; H04W 36/32; H04W 24/08

(52) U.S. Cl. CPC H04W 36/30; H04W 24/08; H04W 36/32

(57) ABSTRACT

A mobile device is provided. The mobile device includes a transceiver and a processor. The transceiver receives wireless signals of a plurality of cells of a mobile network. The cells include a serving cell and at least a neighbor cell. The processor is coupled to the transceiver. The processor performs neighbor cell measurement periodically or in response to a trigger event based on the wireless signal of the neighbor cell. The processor suspends the neighbor cell measurement when the serving cell is not changed for a period of time and a signal quality of the serving cell is equal to or higher than a threshold.

### BACKGROUND OF THE INVENTION

1. Field of the Invention

The present invention relates to a mobile device attached to a mobile network. More particularly, the present invention relates to a mobile device and a method for handling neighbor cell measurement.

2. Description of the Related Art

According to the standard specifications defined by The 3rd Generation Partnership Project (3GPP), a mobile device should perform a cell change decision to determine whether to change the serving cell to make sure the mobile device always camps on the cell with the best signal quality to maintain good quality for the services subscribed by the user, such as mobile telephone service and mobile network service. The cell change decision includes neighbor cell measurement, cell evaluation, cell ranking, and cell reselection.

The cell change decision must be performed periodically or in response to a trigger event when the mobile device is in service. However, the performing of the cell change decision, especially the neighbor cell measurement, significantly consumes power, which is a limited resource in mobile devices.

### SUMMARY OF THE INVENTION

Accordingly, the present invention is directed to a mobile device and a method for handling neighbor cell measurement. The mobile device and the method can selectively perform neighbor cell measurement based on the signal quality of the serving cell and the movement of the mobile device to provide the benefit of power saving.

According to an embodiment of the present invention, a mobile device is provided. The mobile device includes a transceiver and a processor. The transceiver receives wireless signals of a plurality of cells of a mobile network. The cells include a serving cell and at least a neighbor cell. The processor is coupled to the transceiver. The processor performs neighbor cell measurement periodically or in response to a trigger event based on the wireless signal of the neighbor cell. The processor suspends the neighbor cell measurement when the serving cell is not changed for a period of time and a first signal quality of the serving cell is equal to or higher than a first threshold.

According to another embodiment of the present invention, a method for handling neighbor cell measurement is provided. The method is executed by a mobile device having a serving cell in a mobile network, and includes the following steps: performing neighbor cell measurement periodically or in response to a trigger event; and suspending the neighbor cell measurement when the serving cell is not changed for a period of time and a first signal quality of the serving cell is equal to or higher than a first threshold.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a mobile device and a mobile network according to an embodiment of the present invention.

FIG. 2 is a schematic diagram showing a mobile device according to an embodiment of the present invention.

FIG. 3 is a flow chart showing a method for handling neighbor cell measurement according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

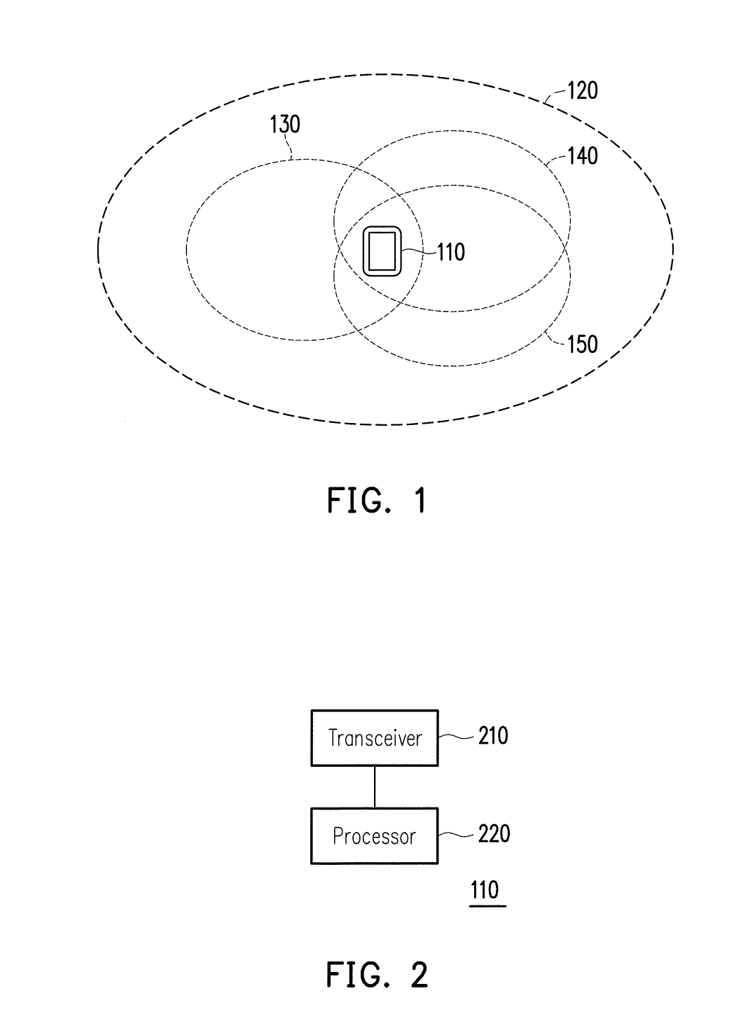

FIG. 1 is a schematic diagram showing a mobile device 110 and a mobile network 120 according to an embodiment of the present invention. The mobile network 120 may be any cellular network based on the standard specifications defined by 3GPP, such as a Global System for Mobile Communications (GSM) network, a General Packet Radio Service (GPRS) network, a Universal Mobile Telecommunications system (UMTS) network or a Long Term Evolution (LTE)/LTE-Advanced network, etc. The mobile device 110 may be any portable electronic device capable of attaching to a mobile network, such as a cell phone or a smartphone. The mobile network 120 includes a plurality of cells, such as the cells 130, 140 and 150. From the point of view of the mobile device 110, the cell 130 is the serving cell which the mobile device 110 camps on, while the cells 140 and 150 are neighbor cells. Although FIG. 1 shows two neighbor cells, the number of neighbor cells is not limited in the present invention.

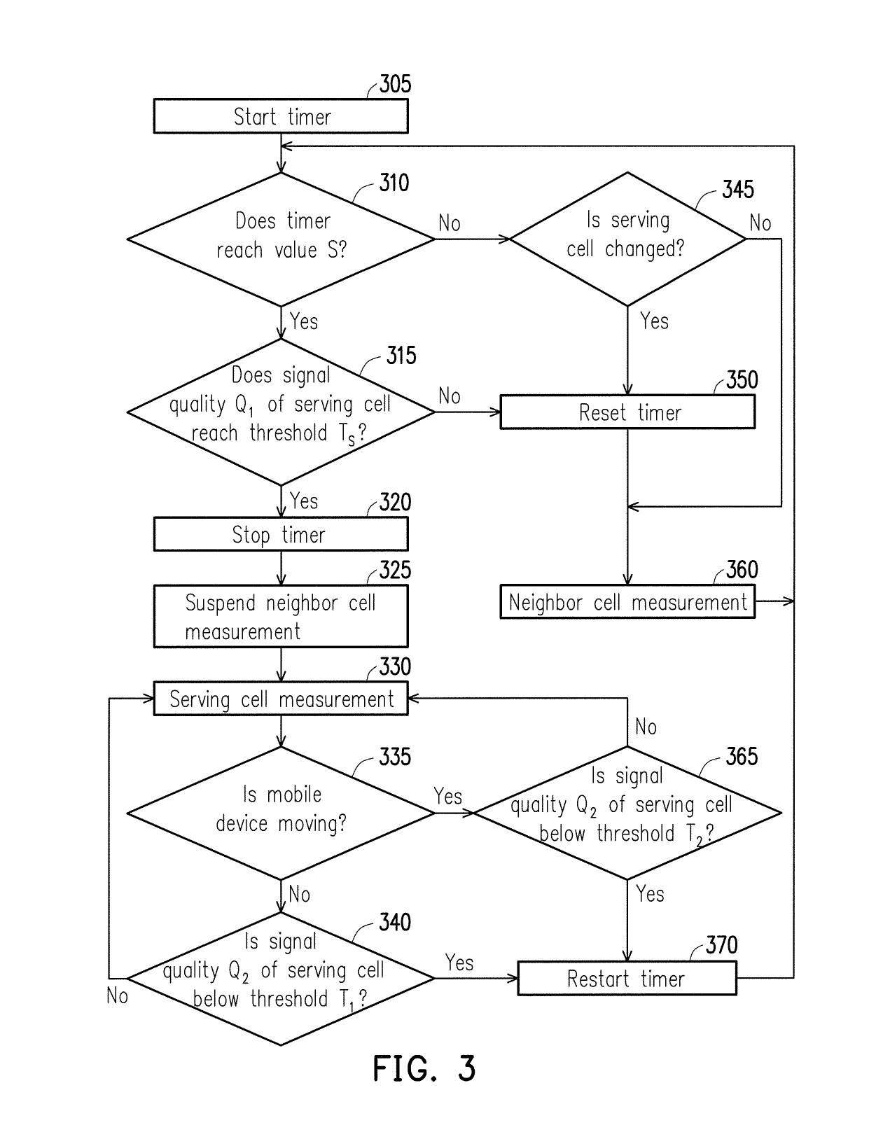

FIG. 2 is a schematic diagram showing the mobile device 110 according to an embodiment of the present invention. The mobile device 110 includes a transceiver 210 and a processor 220. The processor 220 is coupled to the transceiver 210. The transceiver 210 can transmit wireless signals to the mobile network 120 and receive wireless signals from the mobile network 120, so that the processor 220 can communicate with the mobile network 120 through the transceiver 210. The processor 220 may execute the method for handling neighbor cell measurement shown in FIG. 3, which suspends and resumes the neighbor cell measurement adaptively according to the signal quality of the serving cell and the movement of the mobile device 110 to reduce power consumption of the mobile device 110. In the following discussions, the signal quality of a cell may include the signal strength of the same cell. The processor 220 performs serving/neighbor cell measurement based on the wireless signal of the serving/neighbor cell of the mobile network 120 received by the transceiver 210.

FIG. 3 is a flow chart showing a method for handling neighbor cell measurement according to an embodiment of the present invention. The method shown in FIG. 3 may be executed by the processor 220 of the mobile device 110. In step 305, the processor 220 starts a timer. The processor 220 monitors the signal quality of the serving cell (such as the serving cell 130 in FIG. 1) in a period of time. The length of the period of time can be predetermined or dynamically adjusted. The processor 220 measures the period of time with the timer. The timer may be a hardware counter or a software counter.

In step 310, the processor 220 checks whether the timer reaches a timer value S or not. The timer reaching the value S means the end of the period of time mentioned above. When the timer does not reach the value S yet, the flow proceeds to step 345. In step 345, the processor 220 checks whether the serving cell is changed or not. When the serving cell is changed, the processor 220 resets the timer in step 350, and then the flow proceeds to step 360. When the serving cell is not changed, the flow proceeds directly to step 360. The resetting of the timer in step 350 means resetting the timer to the initial value used by the processor 220 to start the timer in step 305.

In step 360, the processor 220 performs the neighbor cell measurement based on the wireless signals of the neighbor cell(s) received by the transceiver 210, and then the flow returns to step 310. The results of the neighbor cell measurement can be used by the processor 220 to determine whether there is another cell with signal quality better than that of the serving cell and whether to change the serving cell to the better cell or not, i.e. the cell change decision. As mentioned above, the whole process of cell change decision includes neighbor cell measurement, cell evaluation, cell ranking, and cell reselection, which are well defined in the specifications of 3GPP and thus the details thereof will not be described here.

When the result of the checking in step 310 is that the timer reaches the value S, the flow proceeds to step 315. In step 315, the processor 220 checks whether or not a signal quality Q₁ of the serving cell is equal to or higher than a predetermined threshold T_{S}. In one embodiment, the signal quality Q₁ is the average signal quality of the serving cell in the period of time counted by the timer. The processor 220 may obtain the signal quality Q₁ of the serving cell from performing serving cell measurement. The details of the serving cell measurement are already discussed in the standard specifications of 3GPP. Therefore, those details are not repeated here.

When the signal quality Q₁ of the serving cell is lower than the predetermined threshold T_{S}, the flow proceeds to step 350. When the signal quality Q₁ of the serving cell is equal to or higher than the predetermined threshold T_{S}, the processor 220 stops the timer in step 320. Next, in step 325, the processor 220 suspends the neighbor cell measurement performed in step 360. The meaning of step 325 is that there is no need to change the serving cell when the signal quality of the serving cell is stable and good enough to maintain the quality of services subscribed by the user. In other words, the neighbor cell measurement may be suspended to save power when the signal quality of the serving cell is stable and good enough.

Next, in step 330, the processor 220 performs serving cell measurement based on the wireless signals of the serving cell received by the transceiver 210 to obtain the current signal quality Q₂ of the serving cell.

In step 335, the processor 220 checks whether the mobile device 110 is moving or not. In one embodiment, the processor 220 may detect the movement of the mobile device 110 through conventional sensors such as gyro-sensor, accelerometer and magnetometer. When the mobile device 110 is not moving, the flow proceeds to step 340. Otherwise, the flow proceeds to step 365. In one embodiment, when the detected moving speed is zero or below a predetermined value, the mobile device 110 is considered as not moving. In step 340, the processor 220 checks whether the signal quality Q₂ of the serving cell is lower than a threshold T₁. When Q₂ is lower than T₁, the processor 220 restarts the timer in step 370 and then the flow returns to step 310. The restarting of the timer in step 370 means restarting the timer with the initial value used by the processor 220 to start the timer in step 305. When Q₂ is not lower than T₁, the flow returns to step 330. In step 365, the processor 220 checks whether the signal quality Q₂ of the serving cell is lower than another threshold T₂. When Q₂ is lower than T₂, the processor 220 restarts the timer in step 370 and then the flow returns to step 310. When Q₂ is not lower than T₂, the flow returns to step 330.

The meaning of steps 335, 340, 365 and 370 is that the neighbor cell measurement should be resumed when the signal quality of the serving cell is too low, so that the serving cell may be changed to another cell with better signal quality. Since the tolerance of the mobile device 110 to low signal quality of the serving cell is lower when the mobile device 110 is moving, the threshold used when the mobile device 110 is moving should be higher. Therefore, the processor 220 assigns different values to the thresholds T₁ and T₂, respectively. The value of the threshold T₁ is lower than the value of the threshold T₂.

In one embodiment, the steps 335, 340 and 365 in FIG. 3 can be replaced by resuming the neighbor cell measurement when the signal quality Q₂ is lower than a threshold T₃, where the threshold T₃ is dynamically adjusted according to a moving speed of the mobile device 110. More specifically, the processor 220 detects the moving speed of the mobile device 110, and determines a value as the threshold T₃ based on the detected moving speed. For example, the higher the detected moving speed is, the larger the value of the threshold T₃ is assigned. Then, the processor 220 determines whether the signal quality Q₂ is lower than the threshold T₃. If yes, the flow proceeds to step 370; otherwise, the flow goes back to step 330.

In summary, the present invention provides a mobile device and a method that adaptively suspend and resume the cell change decision according to the signal quality of the serving cell and the movement of the mobile device to reduce power consumption of the mobile device. By the present invention, the mobile device can still get good subscribed service without constantly performing cell change decision, and further save power because of the suspended cell change decision.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A mobile device, comprising:
a transceiver, receiving wireless signals of a plurality of cells of a mobile network, wherein the cells comprise a serving cell and at least a neighbor cell; and
a processor, coupled to the transceiver, performing neighbor cell measurement periodically or in response to a trigger event based on the wireless signal of the at least a neighbor cell, suspending the neighbor cell measurement when the serving cell is not changed for a period of time and a first signal quality of the serving cell is equal to or higher than a first threshold, performing serving cell measurement based on the wireless signal of the serving cell after suspending the neighbor cell measurement, and resuming the neighbor cell measurement when a second signal quality of the serving cell obtained from the serving cell measurement is lower than a second threshold, wherein the second threshold is dynamically adjusted according to a moving speed of the mobile device, and wherein the higher the detected moving speed is, the larger the value of the second threshold is to be adjusted.

2. The mobile device of claim 1, wherein the first signal quality is an average signal quality of the serving cell during the period of time.

3. The mobile device of claim 2, wherein the processor measures the period of time with a timer and resets the timer when the serving cell is changed.

4-6. (canceled)

7. The mobile device of claim 1, wherein the processor checks whether or not the mobile device is moving, the second threshold is equal to a first value when the mobile device is not moving, the second threshold is equal to a second value when the mobile device is moving, and the first value is lower than the second value.

8. A method for handling neighbor cell measurement, executed by a mobile device having a serving cell in a mobile network, the method comprising:
performing neighbor cell measurement periodically or in response to a trigger event;
suspending the neighbor cell measurement when the serving cell is not changed for a period of time and a first signal quality of the serving cell is equal to or higher than a first threshold;
performing serving cell measurement based on the wireless signal of the serving cell after suspending the neighbor cell measurement; and
resuming the neighbor cell measurement when a second signal quality of the serving cell obtained from the serving cell measurement is lower than a second threshold, wherein the second threshold is dynamically adjusted according to a moving speed of the mobile device, and wherein the higher the detected moving speed is, the larger the value of the second threshold is to be adjusted.

9. The method of claim 8, wherein the first signal quality is an average signal quality of the serving cell during the period of time.

10. The method of claim 9, further comprising:
measuring the period of time with a timer; and
resetting the timer when the serving cell is changed.

11-13. (canceled)

14. The method of claim 8, further comprising:
checking whether or not the mobile device is moving, wherein the second threshold is equal to a first value when the mobile device is not moving, the second threshold is equal to a second value when the mobile device is moving, and the first value is lower than the second value.
